(19) United States
(12) Patent Application Publication
(10) Pub. No.: US 2019/0234343 A1
(43) Pub. Date: Aug. 1, 2019

(54) ORGANIC RANKINE CYCLE WASTE HEAT RECOVERY SYSTEM HAVING TWO LOOPS

(71) Applicant: International Engine Intellectual Property Company, LLC, Lisle, IL (US)

(72) Inventors: James Park, Naperville, IL (US); Jincai Zheng, Lisle, IL (US); James Cigler, Homer Glen, IL (US); Gengxin Han, Naperville, IL (US)

(73) Assignee: International Engine Intellectual Property Company, LLC.

(21) Appl. No.: 15/883,221

(22) Filed: Jan. 30, 2018

(51) Int. Cl. F02G 5/04; F01K 23/06; F01K 25/08

(52) U.S. Cl. CPC F02G 5/04; F02G 2262/00; F01K 25/08; F01K 23/065

(57) ABSTRACT

An Organic Rankine Cycle (ORC) Waste Heat Recovery (WHR) System has an LT working fluid loop and an HT working fluid loop. The working fluid loops may each have a pump, one or more heat exchanger boilers, an expander, and a condenser. A recuperator is arranged within the LT working fluid loop between the pump and the first heat exchanger boiler. The recuperator is also arranged within the HT working fluid loop between the expander and the pump, or within the LT working fluid loop between the expander and the condenser. One of the heat exchanger boilers in the LT loop may be a charge air cooler heat exchanger, and may receive charge air mixed with recirculating exhaust gas. The LT loop may include more than one heat exchanger boiler, arranged in series or in parallel. Bypass valves may selectively bypass one or more of the heat exchangers.

### REFERENCE TO A RELATED APPLICATION AND PRIORITY CLAIM

This application claims priority of, and incorporates by reference, Provisional App. No. 62/508,759, filed May 19, 2017.

### BACKGROUND

### Field of Invention

Embodiments described herein generally relate to an Organic Rankine Cycle (ORC) Waste Heat Recovery (WHR) System for recovering energy otherwise rejected as waste heat via engine cooling, exhaust, charge air cooling, and/or exhaust gas recirculation cooling.

### Related Art

A vehicle, such as a truck, a bus, and the like, is often provided with an engine that converts stored chemical energy in the form of fuel into usable work such as rotational torque and power used to propel the vehicle and to provide for other vehicle power needs. This conversion of chemical energy to usable work is commonly by way of one or more thermodynamic cycles, such as the Otto cycle or the diesel cycle, as non-limiting examples. Due to friction, normal heat losses, and inherent efficiency limitations, the use of such thermodynamic cycles to produce useful work results in the rejection of waste heat to the environment. This commonly takes place by way of a cooling system used to keep the operating machinery of the engine itself within acceptable limits, such as fins for air cooled engines, or a water jacket, radiator, and circulating coolant for water cooled engines. Rejection of waste heat to the environment by an engine utilizing a thermodynamic cycle further takes place by way of the heated exhaust exiting to the environment.

In order to increase the thermal efficiency of such thermodynamic cycles and thereby to improve power and fuel efficiency, it is known to utilize a turbocharger. A turbocharger uses some of the thermal and kinetic energy remaining in the exhaust exiting the engine to drive a turbine, which in turn drives a compressor. The compressor compresses the intake air, which as a result increases in density and temperature. The compressed intake air is therefore commonly passed through an ambient air heat exchanger, known as a charge air cooler, in order to reduce the temperature of the intake, or charge, air before use in the engine. As a result, this charge air cooler further rejects waste heat from the compressed charge air to the environment.

Modern vehicle engines must not only be thermodynamically efficient, but must also minimize exhaust emissions, such as particulates, sulfur oxides, and nitrogen oxides. In order to accomplish this, additional devices and techniques are utilized, such as exhaust gas recirculation and various forms of exhaust aftertreatments, or a combination thereof. Exhaust gas recirculation (EGR), for example, allows a controlled amount of exhaust gas from the engine to flow back into the engine intake, in order to limit the formation of nitrogen oxides during the combustion phase of the thermodynamic cycle. However, exhaust gas recirculation also hinders the thermodynamic efficiency of the engine. To minimize the reduction in thermodynamic efficiency due to exhaust gas recirculation while further reducing the formation of nitrogen oxides, it is known to utilize an exhaust gas recirculation cooler. The exhaust gas recirculation cooler further rejects waste heat from the recirculating exhaust gas to the environment, either directly by heat transfer to ambient air or indirectly by heat transfer to the circulating engine coolant.

The various forms of exhaust aftertreatments used may include diesel particulate filters and various forms of catalysts, reductants, and absorbers, or combinations thereof. Certain of these exhaust aftertreatment devices may produce additional heat directly through exothermic reactions, such as with the use of a catalytic converter. Certain other of these exhaust aftertreatment devices may require periodic thermal regeneration in order to consume accumulated pollutants or to eliminate unwanted compounds. For example, a diesel particulate filter must periodically be raised in temperature in order to burn off accumulated carbon particulates, which may occur by way of dosing the exhaust stream with unburnt fuel. The exothermic reactions or regeneration events utilized in these aftertreatment devices, therefore, further results in rejection of waste heat to the environment.

It is known to use an organic Rankine cycle to recapture some of the energy otherwise rejected as waste heat via engine cooling and/or exhaust. Typically, these organic Rankine cycle systems use a pump, various heat exchangers, evaporators or boilers, and/or superheaters, which recover energy from the waste heat of engine coolant and/or exhaust, an expander that converts the thermal energy of the working fluid to mechanical work, and a condenser. Single loop organic Rankine cycle systems tend to have low overall efficiency, typically less than ten percent, such that it is difficult to significantly improve fuel economy using a system having this configuration.

It is even known to use an organic Rankine cycle having two working fluid loops in order to recapture energy otherwise rejected as waste heat. U.S. Published Application No. 2010/0263380 (the '380 reference) discloses an organic Rankine cycle having a high temperature loop for recapturing waste energy otherwise rejected as waste heat via the engine exhaust, and a low temperature loop for recapturing waste energy otherwise rejected as waste heat via the engine coolant.

The high temperature loop and the low temperature loop of the '380 reference are connected by way of a condenser/evaporator/heat exchanger. The condenser/evaporator/heat exchanger functions as a condenser on the high temperature loop and transfers heat to the low temperature loop where it functions as an evaporator. However, the '380 reference suffers from inefficiency due at least in part to the fact that the working fluid in the low temperature loop has already been heated by the coolant heat exchanger. As a result, the working fluid in the low temperature loop may never be superheated, and the evaporator of the condenser/evaporator/heat exchanger may in fact cool the working fluid before it enters the turbine.

Accordingly, there is an unmet need for a system and method for efficiently recapturing energy presently lost by vehicle engines through these various sources of waste heat.

### SUMMARY

Embodiments described herein relate to an Organic Rankine Cycle (ORC) Waste Heat Recovery (WHR) System having Two Loops for efficiently recovering energy otherwise rejected as waste heat via engine cooling, exhaust, charge air cooling, and/or exhaust gas recirculation (EGR) cooling. Embodiments described herein further relate to a method of using an ORC WHR System having Two Loops to efficiently recover such energy otherwise rejected as waste heat. The ORC WHR System may be applied to various types of engines employing any of a number of thermodynamic cycles. The ORC WHR System may further be applied to engines used in numerous possible applications, including on and off-road vehicles, equipment, stationary applications, and marine applications, as non-limiting examples. The several embodiments of the ORC WHR System presented herein use Otto cycle or diesel cycle vehicle engines as examples, but this is not to be construed as limiting the scope of the ORC WHR System having Two Loops. More specifically, embodiments of the ORC WHR System use a High Temperature (HT) loop and a Low Temperature (LT) loop that may be interconnected by a recuperator or that may each be provided with a separate recuperator.

### ORC WHR System Having Two Coupled Loops

In one embodiment, the ORC WHR System having Two Loops has an LT loop that includes an LT pump, an LT filter, an LT engine coolant heat exchanger/boiler in parallel with an LT Charge Air Cooler (CAC) boiler, an LT expander, and an LT condenser. The LT loop may further have an EGR cooler evaporator boiler subsequent to the rejoinder of the working fluid lines coming from the LT engine coolant heat exchanger/boiler and from the LT CAC boiler, and previous to the LT expander. Alternately, the LT loop may not have an EGR cooler evaporator boiler, and may instead rely upon the LT CAC boiler to absorb the waste heat from the EGR as it joins the intake flow proceeding from the turbocharger compressor.

The ORC WHR System further has an HT loop that includes an HT pump, an HT filter, an HT exhaust boiler, an HT expander, and an HT condenser. A common recuperator transfers heat from the HT loop to the LT loop, such that in the LT loop the recuperator has a first conduit located between the LT pump and an LT proportional valve that controls the fluid mass flow of operating fluid to the LT engine coolant heat exchanger/boiler and to the LT CAC boiler. In the HT loop, the recuperator has a second conduit located between the HT expander and the HT condenser. This may result in the ability to use a smaller condenser in the HT loop. The recuperator may handle only single-phase (gaseous) flow of the working fluid in the low pressure side of the HT loop, or may operate as an additional condenser in the HT loop. Similarly, the recuperator may handle only single-phase (liquid) flow of the working fluid in the high pressure side of the LT loop, or may operate as an initial evaporator in the LT loop.

### ORC WHR System Having Two Decoupled Loops

In another embodiment, the ORC WHR System having Two Loops has an LT loop that includes an LT pump, an LT filter, an LT CAC boiler in series with and preceding an LT engine coolant heat exchanger/boiler, an LT expander, and an LT condenser. The LT loop may further have an LT recuperator having a first conduit located in the working fluid lines between the LT pump and the LT CAC boiler, and having a second conduit located in the working fluid lines between the LT expander and the LT condenser. The LT recuperator then transfers waste heat from the flow of working fluid between the LT expander and the LT condenser to the flow of working fluid between the LT pump and the LT CAC boiler. The LT loop may again not have an EGR cooler evaporator boiler, and may instead rely upon the LT CAC boiler to absorb the waste heat from the EGR as it joins the intake flow proceeding from the turbocharger compressor.

The ORC WHR System having Two Loops further has an HT loop that includes an HT pump, an HT filter, an HT exhaust boiler, an HT expander, and an HT condenser. The HT loop may further have an HT recuperator having a first conduit located in the working fluid lines between the HT pump and the HT exhaust boiler, and having a second conduit located in the working fluid lines between the HT expander and the HT condenser. The HT recuperator then transfers waste heat from the flow of working fluid between the HT expander and the HT condenser to the flow of working fluid between the HT pump and the HT exhaust boiler. This may result in the ability to use a smaller condenser in the low pressure side of the HT loop.

### ORC WHR System Having Two Coupled or Two Decoupled Loops

In any of the embodiments of the ORC WHR System having Two Loops, differing working fluids may be selected for use in the LT loop and in the HT loop. The selection of these working fluids may be based on the system configurations and thermodynamics, as well as upon operating boundaries and characteristics of the working fluids. As a non-limiting example, the working fluid in the LT loop may be a refrigerant fluid such as r134a or r1234zd commonly used for low temperature heat sources, and the working fluid in the HT loop could be a hydrocarbon type of fluid such as cycropentane or ethanol commonly used for high temperature heat sources.

In any of the embodiments of the ORC WHR System having Two Loops, the HT exhaust boiler may be provided with an exhaust gas bypass valve that controls heat transfer rates to the HT exhaust boiler by bypassing the exhaust gas around the HT exhaust boiler under certain conditions. Such conditions may include too high of exhaust gas temperature and/or too high of HT expander inlet temperature and pressure. Further, in any of the embodiments of the ORC WHR System having Two Loops, any of the HT expander and/or the LT expander may be provided with a three-way valve that bypasses the expander under certain conditions. Such conditions may include the working fluid not being entirely in the vapor phase, in which case the three-way valve serves a protective function. Such conditions may further include the working fluid being at too high of a temperature for the expander to handle.

As the heat source of the HT loop of embodiments of the ORC WHR System described is from exhaust energy by way of the HT exhaust boiler, and as heat sources of the LT loop of embodiments of the ORC WHR System are engine coolant and charge air by way of the LT engine coolant heat exchanger/boiler and the LT CAC boiler, the HT loop may be located under the cab of the truck, whereas the LT loop may be located under the hood. In any of the embodiments of the ORC WHR System having Two Loops, power generated by the LT expander and/or by the HT expander may be transmitted by way of mechanical connection to the engine or powertrain of the vehicle. Alternately, the power generated by the LT expander and/or by the HT expander may be used for accessory purposes, such as generating electricity by way of an electrical generator for use in traction batteries or for any other use. All pipes conducting working fluid on the hot temperature side of the LT loop and of the HT loop may be insulated using pipe insulation or double walled pipes in order to maximize ORC WHR System by minimizing heat loss.

### Exemplary Embodiments

According to one embodiment of the ORC WHR System, a vehicle has at least one LT working fluid loop and at least one HT working fluid loop. The at least one LT working fluid loop has in order at least one LT working fluid pump, an LT engine coolant to working fluid heat exchanger and/or an LT CAC boiler, at least one LT working fluid expander, and at least one LT working fluid condenser. The at least one HT working fluid loop has in order at least one HT working fluid pump, at least one HT exhaust to working fluid heat exchanger, and at least one HT working fluid expander. At least one recuperator has a first conduit arranged within the at least one LT working fluid loop between the LT working fluid pump and the LT engine coolant to working fluid heat exchanger and/or LT CAC boiler. The at least one recuperator has a second conduit arranged within the at least one HT working fluid loop between the at least one HT working fluid expander and the at least one HT working fluid pump, or within the at least one LT working fluid loop between the at least one LT working fluid expander and the at least one LT working fluid condenser.

According to another embodiment of the ORC WHR System, at least one LT working fluid loop has in order at least one LT working fluid pump, an LT engine coolant to working fluid heat exchanger and/or an LT CAC boiler, at least one LT working fluid expander, and at least one LT working fluid condenser. At least one HT working fluid loop has in order at least one HT working fluid pump, at least one HT exhaust to working fluid heat exchanger, and at least one HT working fluid expander. At least one recuperator has a first conduit arranged within the at least one LT working fluid loop between the LT working fluid pump and the LT engine coolant to working fluid heat exchanger and/or LT CAC boiler. The at least one recuperator has a second conduit arranged within the at least one HT working fluid loop between the at least one HT working fluid expander and the at least one HT working fluid pump, or within the at least one LT working fluid loop between the at least one LT working fluid expander and the at least one LT working fluid condenser.

According to another embodiment of the ORC WHR System, a method includes several steps. The first step is providing at least one LT ORC WHR working fluid loop having in order at least one LT working fluid pump, an LT engine coolant to working fluid heat exchanger and/or an LT CAC boiler, at least one LT working fluid expander, and at least one LT working fluid condenser. The second step is providing at least one HT ORC WHR working fluid loop having in order at least one HT working fluid pump, at least one HT exhaust to working fluid heat exchanger, and at least one HT working fluid expander. The third step is arranging a first conduit of at least one recuperator within the at least one LT ORC WHR working fluid loop between the LT working fluid pump and the LT engine coolant to working fluid heat exchanger and/or LT CAC boiler. The fourth step is arranging a second conduit of the at least one recuperator within the at least one HT working fluid loop between the at least one HT working fluid expander and the at least one HT working fluid pump, or within the at least one LT working fluid loop between the at least one LT working fluid expander and the at least one LT working fluid condenser.

Embodiments of the ORC WHR System are able to recover significantly more energy previously lost as waste heat through the use of an LT working fluid loop and an HT working fluid loop with appropriate working fluids for each, as well as through the use of a properly arranged and configured recuperator. Through the use of a dedicated HT working fluid loop for the exhaust gas heat exchanger coupled with the use of a recuperator, as much energy as possible can be captured according to the temperature differences between the exhaust gas heat exchanger outlet and the fluid pump outlet. Through the use of a dedicated LT working fluid loop for the LT engine coolant to working fluid heat exchanger and/or LT CAC boiler, in series or in parallel, particularly with the LT engine coolant to working fluid heat exchanger last in the sequence, coupled with the use of a recuperator, as much energy as possible can be captured according to the temperature difference between the LT engine coolant to working fluid heat exchanger and/or LT CAC boiler working fluid outlets and the fluid pump outlet. This allows for increasing the overall Brake Thermal Energy of the vehicle.

In an embodiment of the ORC WHR System wherein the HT working fluid loop includes a condenser, using a recuperator that handles only single phase flow further increases efficiency. In an embodiment of the ORC WHR System wherein EGR flow joins the intake air flow prior to passing through the LT CAC boiler, efficiency is improved and emissions minimized by transferring the heat of the compressed intake air and recirculating exhaust to the ORC WHR System. Embodiments of the ORC WHR System may allow for the elimination of a traditional radiator and EGR cooler, thereby conserving manufacturing and maintenance costs of the vehicle. Furthermore, the use of a separated LT working fluid loop and HT working fluid loop allows for improved vehicle packaging, such as placing the LT working fluid loop in the engine compartment of the vehicle, and placing the HT working fluid loop under the cab of the vehicle.

The high efficiencies achieved by the HT loop of the ORC WHR System having two coupled loops are possible at least in part because none of the HT exhaust boiler exhaust gas temperature profile, the HT exhaust boiler working fluid temperature profile, the HT condenser working fluid temperature profile, the HT condenser coolant temperature profile, the HT loop side common recuperator working fluid temperature profile, or the LT loop side common recuperator working fluid temperature profile cross over each other. The high efficiencies achieved by the LT loop of the ORC WHR System having two coupled loops are possible at least in part because none of the LT engine coolant heat exchanger boiler coolant temperature profile, the LT engine coolant heat exchanger boiler working fluid temperature profile, the LT condenser working fluid temperature profile, the LT condenser coolant temperature profile, the LT CAC boiler air temperature profile, or the LT CAC boiler working fluid temperature profile cross over each other.

The high efficiencies achieved by the HT loop of the ORC WHR System having two decoupled loops are possible at least in part because none of the HT exhaust boiler exhaust gas temperature profile, the HT exhaust boiler working fluid temperature profile, the HT condenser working fluid temperature profile, the HT condenser coolant temperature profile, the HT recuperator master working fluid temperature profile, the first HT recuperator slave working fluid temperature profile, or the second HT recuperator slave working fluid temperature profile cross over each other. The high efficiencies achieved by the LT loop of the ORC WHR System having two decoupled loops are possible at least in part because none of the LT CAC boiler air temperature profile, the LT CAC boiler working fluid temperature profile, the LT engine coolant heat exchanger boiler coolant temperature profile, the LT engine coolant heat exchanger boiler working fluid temperature profile, the LT condenser working fluid temperature profile, the LT condenser coolant temperature profile, the first LT recuperator master working fluid temperature profile, the second LT recuperator master working fluid temperature profile, or the LT recuperator slave working fluid temperature profile cross over each other.

### DESCRIPTION OF THE DRAWINGS

The above-mentioned and other features of embodiments of the Organic Rankine Cycle (ORC) Waste Heat Recovery (WHR) System having Two Loops, and the manner of their working, will become more apparent and will be better understood by reference to the following description of embodiments of the Organic Rankine Cycle Waste Heat Recovery System having Two Loops taken in conjunction with the accompanying drawings, wherein:

FIG. 1 is a graphical representation of a prior art organic Rankine cycle system recovering waste heat from a reciprocating engine;

FIG. 2A is a T-s diagram of a prior art organic Rankine cycle system low temperature loop;

FIG. 2B is a p-h diagram of a prior art organic Rankine cycle system low temperature loop;

FIG. 3 is a graphical representation of an embodiment of an ORC WHR System having two coupled loops, as described herein;

FIG. 4 is a graphical representation of an embodiment of an ORC WHR System having two coupled loops, as described herein;

FIG. 5 is a graphical representation of an embodiment of an ORC WHR System having two decoupled loops, as described herein;

FIG. 6 is a graphical representation of an embodiment of an ORC WHR System having two decoupled loops, as described herein;

Corresponding reference numbers indicate corresponding parts throughout the several views. The exemplifications set out herein illustrate embodiments of an ORC WHR System having Two Loops, and such exemplifications are not to be construed as limiting the scope of the claims in any manner.

### DETAILED DESCRIPTION

### Prior Art

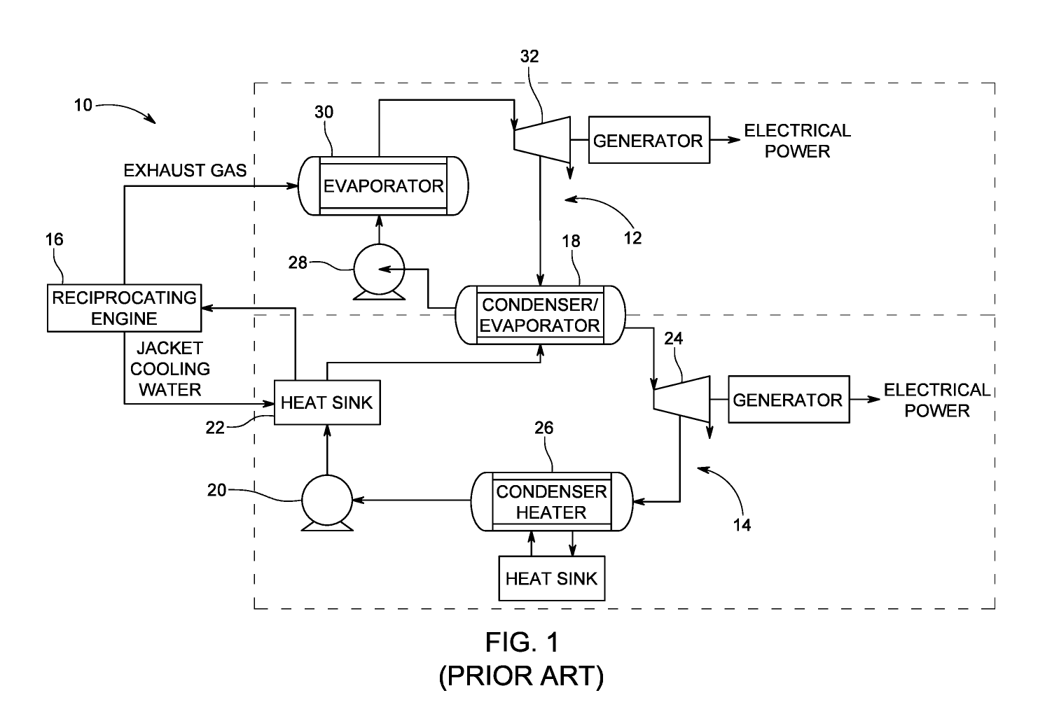

Referring now to FIG. 1, a graphical representation of a prior art Organic Rankine Cycle system 10 recovering waste heat from a reciprocating engine is shown. The prior art organic Rankine cycle system 10 is provided with a Low Temperature (LT) loop 14, a High Temperature (HT) loop 12, and a common condenser/evaporator 18. The LT loop 14 is provided with an LT pump 20, an LT engine coolant heat exchanger/boiler 22, the common condenser/evaporator 18 functioning as an evaporator in the LT loop 14, an LT expander 24, and an LT condenser 26. The HT loop 12 is provided with an HT pump 28, an HT exhaust boiler 30, an HT expander 32, and the common condenser/evaporator 18 functioning as a condenser in the HT loop 12.

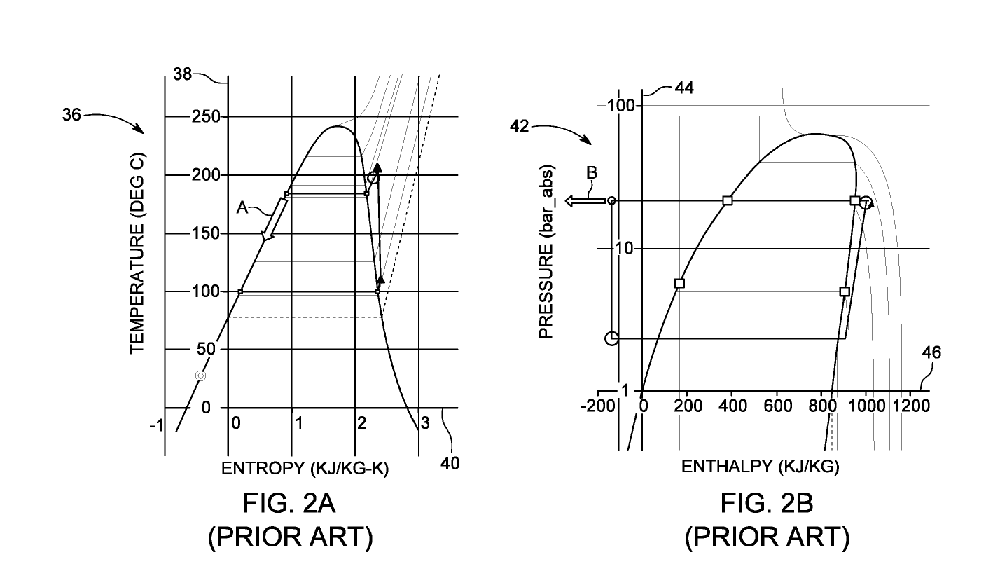

FIG. 2A shows a T-s diagram 36 of the prior art Organic Rankine Cycle System 10 LT loop 14, having vertical axis 38 representing the temperature of the working fluid and having horizontal axis 40 representing entropy of the working fluid. Arrow A represents the thermodynamic change in the working fluid coming from the LT engine coolant heat exchanger/boiler 22 as it passes through the common condenser/evaporator 18 in the LT loop 14. FIG. 2A shows a p-h diagram 42 of the prior art Organic Rankine Cycle System 10 LT loop 14, having vertical axis 44 representing the temperature of the working fluid and having horizontal axis 46 representing the enthalpy of the working fluid. Arrow B also represents the thermodynamic change in the working fluid coming from the LT engine coolant heat exchanger/boiler 22 as it passes through the common condenser/evaporator 18 in the LT loop 14. As can be seen, due to the position of the common condenser/evaporator 18 in the LT loop 14 subsequent to the LT engine coolant heat exchanger/boiler 22 and before the LT expander 24, the working fluid in the LT loop 14 may not achieve a superheated state. In fact, the common condenser/evaporator 18 may inefficiently cool the working fluid coming from the LT engine coolant heat exchanger/boiler 22.

### ORC WHR System Having Two Coupled Loops

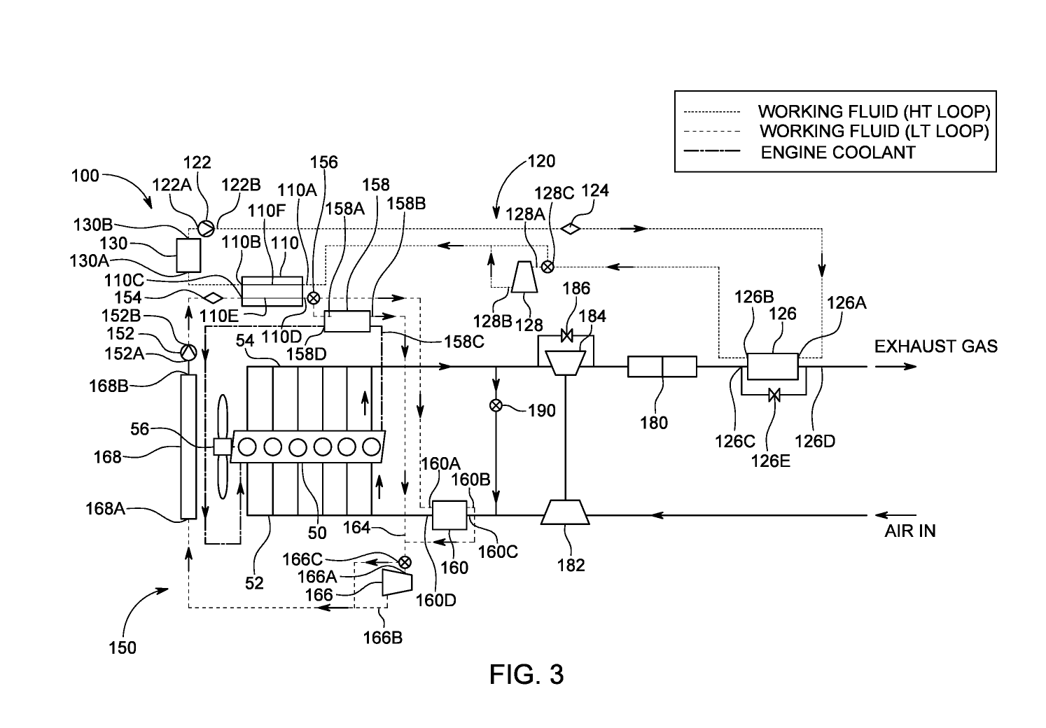

Turning now to FIG. 3, a graphical representation of an embodiment of an Organic Rankine Cycle (ORC) Waste Heat Recovery (WHR) System 100 having two coupled loops is shown. A reciprocating engine 50 has an intake manifold 52, an exhaust manifold 54, and an engine cooling fan 56. A turbocharger turbine 184 converts some of the heat and flow of the exhaust from exhaust manifold 54 to mechanical energy, which is used to drive a turbocharger compressor 182. The turbocharger compressor 182 compresses intake air that travels to the intake manifold 52, resulted in a desired increase in the density of the intake air, but also resulting in unwanted heating of the intake air. Exhaust flow in excess of that which is needed by the turbocharger turbine 184 may bypass the turbocharger turbine by way of a turbocharger waste gate 186. Some of the exhaust flow is allowed to return from the exhaust manifold 54 to the intake manifold 52 under the control of an Exhaust Gas Recirculation (EGR) valve 190, for purposes of limiting the formation of undesirable exhaust pollutants. Further undesirable exhaust pollutants may be removed from the flow of exhaust subsequent to the turbocharger turbine 184 using an exhaust aftertreatment system 180, which may generate substantial heat in operation.

The ORC WHR System 100 having two coupled loops is provided with an LT loop 150 and an HT loop 120. The LT loop 150 has an LT pump 152 with an LT pump fluid inlet 152A and an LT pump fluid outlet 152B. Working fluid in the liquid phase is pressurized by the LT pump 152 and proceeds from the LT pump fluid outlet 152B through an LT filter 154 to an LT proportional valve 156 by way of a common recuperator 110, the function of which will be discussed in detail later on. The LT proportional valve 156 divides the flow of working fluid between an LT engine coolant heat exchanger/boiler 158 and an LT Charge Air Cooler (CAC) boiler 160, which are arranged in parallel circuits of the LT loop 150. Working fluid is admitted to the LT engine coolant heat exchanger/boiler fluid inlet 158A of the LT engine coolant heat exchanger/boiler 158 and to the LT CAC boiler fluid inlet 160A of the LT CAC boiler 160, according to the proportion governed by the LT proportional valve 156. Alternately, the LT CAC boiler 160 and the LT engine coolant heat exchanger/boiler 158 may be arranged in series, with the LT CAC boiler 160 arranged before the LT engine coolant heat exchanger/boiler 158, or with the LT engine coolant heat exchanger/boiler 158 arranged before the LT CAC boiler 160.

Meanwhile, engine coolant enters the LT engine coolant heat exchanger/boiler 158 at LT engine coolant heat exchanger/boiler coolant inlet 158C, transfers heat to the working fluid of the LT loop 150, and returns to the reciprocating engine 50 by way of the LT engine coolant heat exchanger/boiler coolant outlet 158D. The working fluid exits the LT engine coolant heat exchanger/boiler 158 at LT engine coolant heat exchanger/boiler fluid outlet 158B, having absorbed heat and transitioned to a gaseous phase. Similarly, charge air enters the LT CAC boiler 160 at an LT CAC boiler air inlet 160C, and may include exhaust flow from the exhaust manifold 54 which has joined the intake air by way of the EGR valve 190. Heat from the compressed intake air and from the EGR exhaust flow transfers to the working fluid of the LT loop 150, and the intake air mixed with EGR exhaust flow exits the CAC boiler 160 at LT CAC boiler air outlet 160D before entering the intake manifold 52. The working fluid exits the LT CAC boiler 160 at LT CAC boiler fluid outlet 160B, having also absorbed heat and transitioned to a gaseous phase.

The gaseous working fluid exiting the LT engine coolant heat exchanger/boiler 158 at LT engine coolant heat exchanger/boiler fluid outlet 158B and the gaseous working fluid exiting the LT CAC boiler 160 at LT CAC boiler fluid outlet 160B recombine at combined LT engine coolant heat exchanger/boiler & LT CAC boiler fluid outlet 164. The gaseous working fluid then enters an LT expander 166 by way of LT expander fluid inlet 166A. The LT expander 166 extracts useful work from the heat and flow of the gaseous working fluid, before the spent low pressure working fluid exits the LT expander 166 by way of LT expander fluid outlet 166B. An LT bypass valve 166C may cause the working fluid to bypass the LT expander 166 under certain conditions. Such conditions may include the working fluid not being entirely in the vapor phase, in which case the LT bypass valve 166C serves a protective function, or the working fluid being at too high of a temperature for the LT expander 166 to handle.

Spent low pressure working fluid then exits the LT expander 166 by way of LT expander fluid outlet 166B and enters an LT condenser 168 by way of an LT condenser fluid inlet 168A. As the spent low pressure working fluid passes through the LT condenser 168, waste heat is rejected to the environment, and the working fluid returns to a liquid state before exiting the LT condenser fluid outlet 168B. The liquid working fluid then enters the LT pump 152 at the LT pump fluid inlet 152A, and the cycle begins again.

The HT loop 120 has an HT pump 122 with an HT pump fluid inlet 122A and an HT pump fluid outlet 122B. Working fluid in the liquid phase is pressurized by the HT pump 122 and proceeds from the HT pump fluid outlet 122B through an HT filter 124 to an HT exhaust boiler 126. Working fluid is admitted to the HT exhaust boiler fluid inlet 126A of the HT exhaust boiler 126. At the same time, heated exhaust from the exhaust aftertreatment system 180 is admitted to the HT exhaust boiler 126 at HT exhaust boiler exhaust inlet 126C and transfers heat from the flow of exhaust to the working fluid of the HT loop 120, before exiting the HT exhaust boiler 126 at HT exhaust boiler exhaust outlet 126D. The working fluid then exits the HT exhaust boiler 126 at HT exhaust boiler fluid outlet 126B, having absorbed heat and transitioned to a gaseous phase. An exhaust gas bypass valve 126E may bypass the exhaust gas around the HT exhaust boiler 126 under certain conditions, in order to controls heat transfer rates to the working fluid of the HT loop 120. Such conditions may include too high of exhaust gas temperature and/or too high of HT expander fluid inlet temperature and pressure.

The gaseous working fluid then enters an HT expander 128 by way of an HT expander fluid inlet 128A. The HT expander 128 extracts useful work from the heat and flow of the gaseous working fluid, before the spent low pressure working fluid exits the HT expander 128 by way of HT expander fluid outlet 128B. An HT bypass valve 128C may cause the working fluid to bypass the HT expander 128 under certain conditions, such as the working fluid not being entirely in the vapor phase, in which case the HT bypass valve 128C serves a protective function, or the working fluid being at too high of a temperature for the HT expander 128 to handle. Spent low pressure working fluid exits the HT expander 128 by way of HT expander fluid outlet 128B and passes through the common recuperator 110 before entering an HT condenser 130 by way of an HT condenser fluid inlet 130A. As the spent low pressure working fluid passes through the HT condenser 130, waste heat is rejected to the environment, and the working fluid returns to a liquid state before exiting the HT condenser fluid outlet 130B. The liquid working fluid then enters the HT pump 122 at the LT pump fluid inlet 122A, and the cycle begins again.

The common recuperator 110 has a common recuperator first conduit 110E located between the LT pump 152 and the LT proportional valve 156 that controls the fluid mass flow of operating fluid to the LT engine coolant heat exchanger/boiler 158 and to the LT CAC boiler 160 in the LT loop 150. Alternately, in an embodiment employing the LT CAC boiler 160 and the LT engine coolant heat exchanger/boiler in a series arrangement, the common recuperator first conduit 110E is located between the LT pump 152 and the first of the LT engine coolant heat exchanger/boiler 158 and the LT CAC boiler 160. In the HT loop 120, the common recuperator 110 has a common recuperator second conduit 110F located between the HT expander 128 and the HT condenser 130.

Working fluid of the LT loop 150 enters the common recuperator 110 at the common recuperator LT fluid inlet 110C and exits the common recuperator 110 at the common recuperator LT fluid outlet 110D. Working fluid of the HT loop 120 enters the common recuperator 110 at the common recuperator HT fluid inlet 110A and exits the common recuperator 110 at the common recuperator HT fluid outlet 110B. In this way, the common recuperator 110 transfers heat from the working fluid of the HT loop 120 to the working fluid of the LT loop 150. The recuperator may handle only single-phase (gaseous) flow of the working fluid in the low pressure side of the HT loop 120, or may operate as an additional condenser in the HT loop 120. Similarly, the recuperator may handle only single-phase (liquid) flow of the working fluid in the high pressure side of the LT loop 150, or may operate as an initial evaporator in the LT loop 150.

### ORC WHR System Having Two Coupled Loops

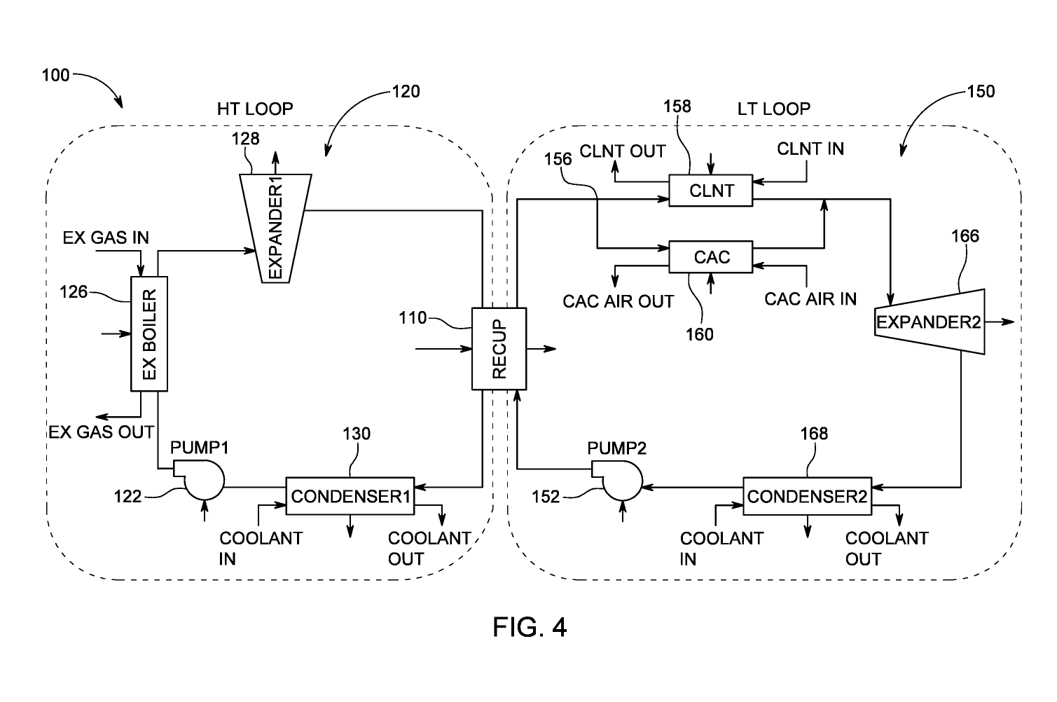

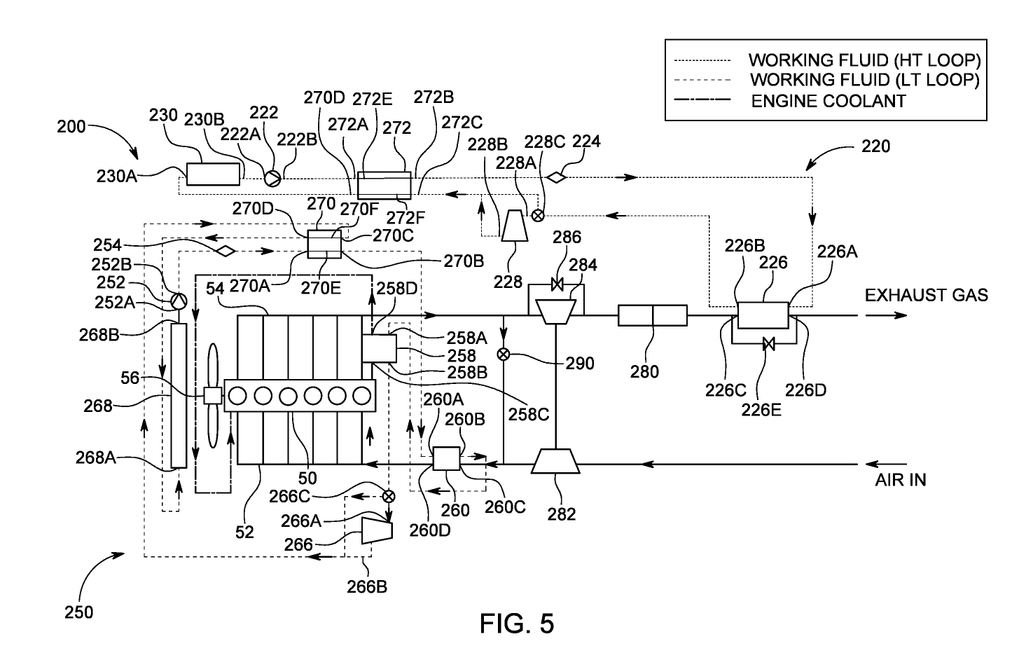

Turning now to FIG. 4, another simplified graphical representation is shown of an embodiment of an ORC WHR System 100 having two coupled loops, similar to the ORC WHR System 100 that appears in FIG. 3. The embodiment of the ORC WHR System 100 having two coupled loops shown in FIGS. 5 through 7 differs slightly from that shown in FIGS. 3 and 4, in that LT condenser 168 and HT condenser 130 are liquid cooled. The ORC WHR System 100 having two coupled loops is again provided with an LT loop 150 and an HT loop 120. The LT loop 150 again has an LT pump 152. The working fluid of the LT loop 150 may be r245fa. Working fluid in the liquid phase enters LT pump 152 and is pressurized by the LT pump 152. The working fluid then proceeds to an LT proportional valve 156 by way of a common recuperator 110. The LT proportional valve 156 divides the flow of working fluid between an LT engine coolant heat exchanger/boiler 158 and an LT CAC boiler 160, which are arranged in parallel circuits of the LT loop 150. Working fluid is admitted to the LT engine coolant heat exchanger/boiler 158 and to of the LT CAC boiler 160, according to the proportion governed by the LT proportional valve 156. Alternately, the LT CAC boiler 160 and the LT engine coolant heat exchanger/boiler 158 may be arranged in series, with the LT CAC boiler 160 arranged before the LT engine coolant heat exchanger/boiler 158, or with the LT engine coolant heat exchanger/boiler 158 arranged before the LT CAC boiler 160.

Meanwhile, engine coolant enters the LT engine coolant heat exchanger/boiler 158, transfers heat to the working fluid of the LT loop 150, and exits the LT engine coolant heat exchanger/boiler 158. The working fluid then exits the LT engine coolant heat exchanger/boiler 158 having absorbed heat and transitioned to a gaseous phase. Similarly, charge air enters the LT CAC boiler 160, which may include exhaust flow from the exhaust manifold 54 (not shown in FIG. 4) which has joined the intake air by way of the EGR valve 190 (not shown in FIG. 4). Heat from the compressed intake air and from the EGR exhaust flow transfers to the working fluid of the LT loop 150, and the intake air mixed with EGR exhaust flow then exits the LT CAC boiler 160 before entering the intake manifold 52 (not shown in FIG. 4). The working fluid then exits the LT CAC boiler 160 having also absorbed heat and transitioned to a gaseous phase.

The gaseous working fluid exiting the LT engine coolant heat exchanger/boiler 158 and the gaseous working fluid exiting the LT CAC boiler 160 recombines and then enters an LT expander 166. The LT expander 166 then extracts useful work from the heat and flow of the gaseous working fluid. The spent low pressure working fluid then exits the LT expander 166 and enters an LT condenser 168. As the spent low pressure working fluid passes through the LT condenser 168, waste heat is rejected to a flow of coolant, and the working fluid returns to a liquid state before exiting the LT condenser 168. The liquid working fluid then enters the LT pump 152, and the cycle begins again.

The HT loop 120 again has an HT pump 122. The working fluid of the HT loop 120 may be r1336mzzZ. Working fluid enters the HT pump 122 and is pressurized by the HT pump 122. The working fluid then proceeds to an HT exhaust boiler 126. At the same time, heated exhaust from the exhaust aftertreatment system 180 (not shown in FIG. 4) is admitted to the HT exhaust boiler 126, and transfers heat from the flow of exhaust to the working fluid of the HT loop 120, before exiting the HT exhaust boiler 126. The working fluid then exits the HT exhaust boiler 126 having absorbed heat and transitioned to a gaseous phase. The gaseous working fluid then enters an HT expander 128. The HT expander then extracts useful work from the heat and flow of the gaseous working fluid. Spent low pressure working fluid exits the HT expander 128, and passes through the common recuperator 110 before entering an HT condenser 130. As the spent low pressure working fluid passes through the HT condenser 130, waste heat is rejected to a flow of coolant, and the working fluid returns to a liquid state before exiting the HT condenser 130. The liquid working fluid then enters the HT pump 122, and the cycle begins again.

The common recuperator 110 is again located between the LT pump 152 and the LT proportional valve 156 that controls the fluid mass flow of operating fluid to the LT engine coolant heat exchanger/boiler 158 and to the LT CAC boiler 160 in the LT loop 150. Alternately, in an embodiment employing the LT CAC boiler 160 and the LT engine coolant heat exchanger/boiler in a series arrangement, the common recuperator first conduit 110E is located between the LT pump 152 and the first of the LT engine coolant heat exchanger/boiler 158 and the LT CAC boiler 160. In the HT loop 120, the common recuperator 110 is located between the HT expander 128 and the HT condenser 130. The common recuperator 110 transfers heat from the working fluid of the HT loop 120 to the working fluid of the LT loop 150. The recuperator may handle only single-phase (gaseous) flow of the working fluid in the low pressure side of the HT loop 120, or may operate as an additional condenser in the HT loop 120. Similarly, the recuperator may handle only single-phase (liquid) flow of the working fluid in the high pressure side of the LT loop 150, or may operate as an initial evaporator in the LT loop 150.

### ORC WHR System Having Two Decoupled Loops

Turning now to FIG. 5, a graphical representation of an embodiment of an ORC WHR System 200 having two decoupled loops is shown. A reciprocating engine 50 has an intake manifold 52, an exhaust manifold 54, and an engine cooling fan 56. A turbocharger turbine 284 converts some of the heat and flow of the exhaust from exhaust manifold 54 to mechanical energy, which is used to drive a turbocharger compressor 282. The turbocharger compressor 282 compresses intake air that travels to the intake manifold 52, resulted in a desired increase in the density of the intake air, but also resulting in unwanted heating of the intake air. Exhaust flow in excess of that which is needed by the turbocharger turbine 284 may bypass the turbocharger turbine by way of a turbocharger waste gate 286. Some of the exhaust flow is allowed to return from the exhaust manifold 54 to the intake manifold 52 under the control of an EGR valve 290, for purposes of limiting the formation of undesirable exhaust pollutants. Further undesirable exhaust pollutants may be removed from the flow of exhaust subsequent to the turbocharger turbine 284 using an exhaust aftertreatment system 280, which often generates substantial heat in operation.

The ORC WHR System 200 having two decoupled loops is provided with an LT loop 250 and an HT loop 220. The LT loop 250 has an LT pump 252 with an LT pump fluid inlet 252A and an LT pump fluid outlet 252B. Working fluid in the liquid phase is pressurized by the LT pump 252 and proceeds from the LT pump fluid outlet 252B through an LT filter 254 to an LT recuperator 270, the function of which will be discussed in detail later on. The working fluid of the LT loop 250 is then conducted to the LT CAC boiler fluid inlet 260A of an LT CAC boiler 260. At the same time, charge air enters the LT CAC boiler 260 at an LT CAC boiler air inlet 260C, and may include exhaust flow from the exhaust manifold 54 which has joined the intake air by way of the EGR valve 290. Heat from the compressed intake air and from the EGR exhaust flow transfers to the working fluid of the LT loop 250, and the intake air mixed with EGR exhaust flow exits the CAC boiler 260 at LT CAC boiler air outlet 260D before entering the intake manifold 52. The working fluid exits the LT CAC boiler 260 at LT CAC boiler fluid outlet 260B, having also absorbed heat and at least partially transitioned to a gaseous phase.

The working fluid of the LT loop 250 is then conducted to the LT engine coolant heat exchanger/boiler fluid inlet 258A of an LT engine coolant heat exchanger/boiler 258. Meanwhile, engine coolant enters the LT engine coolant heat exchanger/boiler 258 at LT engine coolant heat exchanger/boiler coolant inlet 258C, transfers heat to the working fluid of the LT loop 250, and returns to the reciprocating engine 50 by way of the LT engine coolant heat exchanger/boiler coolant outlet 258D. The working fluid exits the LT engine coolant heat exchanger/boiler 258 at LT engine coolant heat exchanger/boiler fluid outlet 258B, having absorbed heat and fully transitioned to a gaseous phase. Alternately, the CAC boiler 260 and the LT engine coolant heat exchanger/boiler 258 may be arranged in parallel circuits with respect to the flow of working fluid in the LT loop 250.

The gaseous working fluid then enters an LT expander 266 by way of LT expander fluid inlet 266A. The LT expander 266 extracts useful work from the heat and flow of the gaseous working fluid, before the spent low pressure working fluid exits the LT expander 266 by way of LT expander fluid outlet 266B. An LT bypass valve 266C may cause the working fluid to bypass the LT expander 166 under certain conditions. Such conditions may include the working fluid not being entirely in the vapor phase, in which case the LT bypass valve 266C serves a protective function, or the working fluid being at too high of a temperature for the LT expander 266 to handle. Spent low pressure working fluid exits the LT expander 266 by way of LT expander fluid outlet 266B and passes again through the LT recuperator 270 before entering an LT condenser 268 by way of an LT condenser fluid inlet 268A. As the spent low pressure working fluid passes through the LT condenser 268, waste heat is rejected to the environment, and the working fluid returns to a liquid state before exiting the LT condenser fluid outlet 268B. The liquid working fluid then enters the LT pump 252 at the LT pump fluid inlet 252A, and the cycle begins again.

The LT recuperator 270 has an LT recuperator first conduit 270E located between the LT pump 252 and the LT CAC boiler 260 in the LT loop 250 and an LT recuperator second conduit 270F located between the LT expander 266 and the LT condenser 268. Working fluid of the LT loop 250 enters the LT recuperator 270 at the LT recuperator fluid inlet from pump 270A and exits the LT recuperator 270 at the LT recuperator fluid outlet to CAC boiler 270B. In an embodiment wherein the LT CAC boiler 260 and the LT engine coolant heat exchanger/boiler 258 are arranged in parallel circuits with respect to the flow of working fluid in the LT loop 250, the LT recuperator first conduit 270E is located between the LT pump 252 and the dividing point between working fluid going to the LT engine coolant heat exchanger/boiler 258 and working fluid going to the LT CAC boiler 260. Working fluid of the LT loop 250 also enters the LT recuperator 270 at the LT recuperator fluid inlet from expander 270C and exits the LT recuperator 270 at the LT recuperator fluid outlet to condenser 270D. In this way, the LT recuperator 270 transfers residual heat from the low pressure spent working fluid of the LT loop 250 passing from the LT expander 266 to the LT condenser 268, to the cool pressurized working fluid of the LT loop 250 passing from the LT pump 252 to the LT CAC boiler 260 and/or to the LT engine coolant heat exchanger/boiler 258. The LT recuperator may handle only single-phase (liquid) flow of the working fluid in the high pressure side of the LT loop 250, or may operate as an initial evaporator in the LT loop 250. The recuperator may handle only single-phase (gaseous) flow of the working fluid in the low pressure side of the LT loop 250, or may operate as an additional condenser in the LT loop 250.

The HT loop 220 has an HT pump 222 with an HT pump fluid inlet 222A and an HT pump fluid outlet 222B. Working fluid in the liquid phase is pressurized by the HT pump 222 and proceeds from the HT pump fluid outlet 222B through an HT filter 224 to an HT exhaust boiler 226, by way of an HT recuperator 272, the function of which will be explained later. Working fluid is admitted to the HT exhaust boiler fluid inlet 226A of the HT exhaust boiler 226. At the same time, heated exhaust from the exhaust aftertreatment system 280 is admitted to the HT exhaust boiler 226 at HT exhaust boiler exhaust inlet 226C and transfers heat from the flow of exhaust to the working fluid of the HT loop 220, before exiting the HT exhaust boiler 226 at HT exhaust boiler exhaust outlet 226D. The working fluid then exits the HT exhaust boiler 226 at HT exhaust boiler fluid outlet 226B, having absorbed heat and transitioned to a gaseous phase. An exhaust gas bypass valve 226E may bypass the exhaust gas around the HT exhaust boiler 226 under certain conditions, such as in order to control heat transfer rates to the working fluid of the HT loop 220. Such conditions may further include too high of exhaust gas temperature and/or too high of HT expander fluid inlet temperature and pressure.

The gaseous working fluid then enters an HT expander 228 by way of an HT expander fluid inlet 228A. The HT expander 228 extracts useful work from the heat and flow of the gaseous working fluid, before the spent low pressure working fluid exits the HT expander 228 by way of HT expander fluid outlet 228B. An HT bypass valve 228C may cause the working fluid to bypass the HT expander 228 under certain conditions, such as the working fluid not being entirely in the vapor phase, in which case the HT bypass valve 228C serves a protective function, or the working fluid being at too high of a temperature for the HT expander 228 to handle. Spent low pressure working fluid exits the HT expander 228 by way of HT expander fluid outlet 228B and passes again through the HT recuperator 272 before entering an HT condenser 230 by way of an HT condenser fluid inlet 230A. As the spent low pressure working fluid passes through the HT condenser 230, waste heat is rejected to the environment, and the working fluid returns to a liquid state before exiting the HT condenser fluid outlet 230B. The liquid working fluid then enters the HT pump 222 at the LT pump fluid inlet 222A, and the cycle begins again.

The HT recuperator 272 has an HT recuperator first conduit located between the HT pump 222 and the HT exhaust boiler 226 in the HT loop 220 and an HT recuperator second conduit located between the HT expander 228 and the HT condenser 230. Working fluid of the HT loop 220 enters the HT recuperator 272 at the HT recuperator fluid inlet from pump 272A and exits the HT recuperator 272 at the HT recuperator fluid outlet to exhaust boiler 272B. Working fluid of the HT loop 220 also enters the HT recuperator 272 at the HT recuperator fluid inlet from expander 272C and exits the HT recuperator 272 at the HT recuperator fluid outlet to condenser 272D. In this way, the HT recuperator 272 transfers residual heat from the low pressure spent working fluid of the HT loop 220 passing from the HT expander 228 to the HT condenser 230, to the cool pressurized working fluid of the HT loop 220 passing from the HT pump 222 to the HT exhaust boiler 226. The HT recuperator 272 may handle only single-phase (liquid) flow of the working fluid in the high pressure side of the HT loop 220, or may operate as an initial evaporator in the HT loop 220. The recuperator may handle only single-phase (gaseous) flow of the working fluid in the low pressure side of the HT loop 220, or may operate as an additional condenser in the HT loop 220.

### ORC WHR System Having Two Decoupled Loops

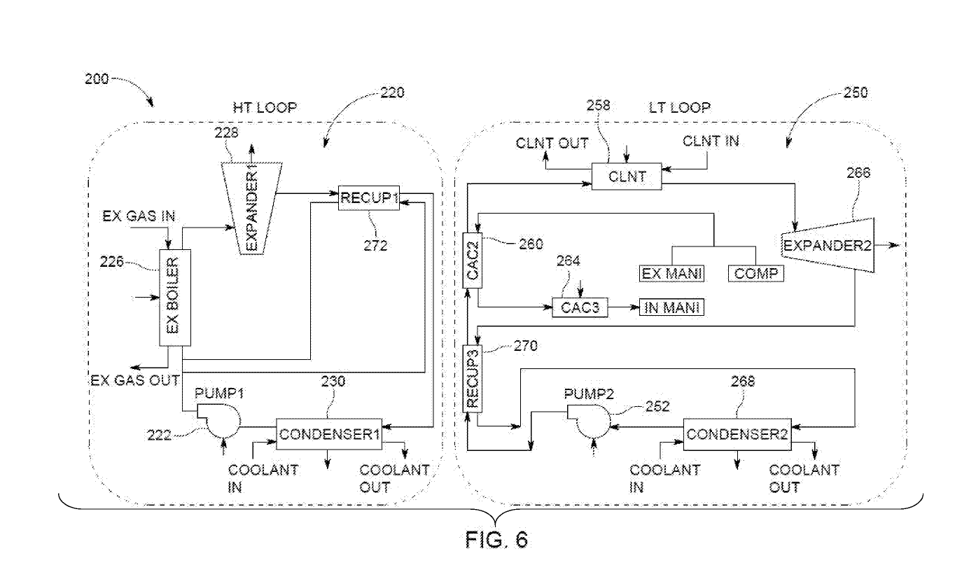

Turning now to FIG. 6, a simplified graphical representation is shown of an embodiment of an ORC WHR System 200 having two decoupled loops, similar to the ORC WHR System 200 that appears in FIG. 5. The embodiment of the ORC WHR System 200 having two decoupled loops shown in FIG. 6 differs slightly from that shown in FIG. 5, in that LT condenser 268 and HT condenser 230 are liquid cooled. The embodiment of the ORC WHR System 200 having two decoupled loops shown in FIG. 6 differs further from that shown in FIG. 5 in that a second CAC 264 is provided to ensure sufficient cooling of charge air entering the intake manifold 52 (not shown in FIG. 6). The ORC WHR System 200 having two decoupled loops is again provided with an LT loop 250 and an HT loop 220. The LT loop 250 again has an LT pump 252. The working fluid of the LT loop 250 may be r245fa. Working fluid enters LT pump 252 and is pressurized by the LT pump 252. The working fluid then proceeds by way of an LT recuperator 270, the function of which will be explained later.

The working fluid in the LT loop 250 coming from the LT recuperator 270 is conducted to an LT CAC boiler 260. At the same time, charge air enters the LT CAC boiler 260, which in the case of the example in FIG. 6 does not include any EGR exhaust flow from the exhaust manifold 54 (not shown in FIG. 6), and includes 100% of the charge air flow from the turbocharger compressor 282 (not shown in FIG. 6). Heat from the compressed intake air transfers to the working fluid of the LT loop 250, and then the intake air exits the LT CAC boiler 260. The working fluid exits the LT CAC boiler 260 having also absorbed heat and at least partially transitioned to a gaseous phase. The compressed intake air then continues to second CAC 264 to be cooled further. The working fluid of the LT loop 250 is then conducted to an LT engine coolant heat exchanger/boiler 258. Meanwhile, engine coolant enters the LT engine coolant heat exchanger/boiler 258, transfers heat to the working fluid of the LT loop 250, and exits the LT engine coolant heat exchanger/boiler 258. The working fluid then exits the LT engine coolant heat exchanger/boiler 258 having absorbed heat and fully transitioned to a gaseous phase. Alternately, the CAC boiler 260 and the LT engine coolant heat exchanger/boiler 258 may be arranged in parallel circuits with respect to the flow of working fluid in the LT loop 250.

The gaseous working fluid exiting the LT engine coolant heat exchanger/boiler 258 then enters an LT expander 266. The LT expander 266 then extracts useful work from the heat and flow of the gaseous working fluid. The spent low pressure working fluid then exits the LT expander 266, passes again through the LT recuperator 270, and enters an LT condenser 268. As the spent low pressure working fluid passes through the LT condenser 268, waste heat is rejected to a flow of coolant, and the working fluid returns to a liquid state before exiting the LT condenser 268. The liquid working fluid then enters the LT pump 252, and the cycle begins again.

The LT recuperator 270 is again located in the LT loop 250 between the LT pump 252 and the LT CAC boiler 260, and again between the LT expander 266 and the LT condenser 268. In this way, the LT recuperator 270 transfers residual heat from the low pressure spent working fluid of the LT loop 250 passing from the LT expander 266 to the LT condenser 268, to the cool pressurized working fluid of the LT loop 250 passing from the LT pump 252 to the LT CAC boiler 260. In an embodiment wherein the LT CAC boiler 260 and the LT engine coolant heat exchanger/boiler 258 are arranged in parallel circuits with respect to the flow of working fluid in the LT loop 250, the LT recuperator 270 is located between the LT pump 252 and the dividing point between working fluid going to the LT engine coolant heat exchanger/boiler 258 and working fluid going to the LT CAC boiler 260, and again between the LT expander 266 and the LT condenser 268.

The HT loop 220 again has an HT pump 222. The working fluid of the HT loop 220 may be r245fa. Working fluid in the liquid phase enters the HT pump 222 and is pressurized by the HT pump 222. The working fluid then proceeds by way of an HT recuperator 272, the function of which will be explained later. The working fluid in the HT loop 220 coming from the HT recuperator 272 is then conducted to an HT exhaust boiler 226. At the same time, heated exhaust from the exhaust aftertreatment system 280 (not shown in FIG. 6) is admitted to the HT exhaust boiler 226, and transfers heat from the flow of exhaust to the working fluid of the HT loop 220, before exiting the HT exhaust boiler 226. The working fluid then exits the HT exhaust boiler 226 having absorbed heat and transitioned to a gaseous phase. The gaseous working fluid then enters an HT expander 228. The HT expander 228 then extracts useful work from the heat and flow of the gaseous working fluid. Spent low pressure working fluid exits the HT expander 228 and passes through the HT recuperator 272 before entering an HT condenser 230. As the spent low pressure working fluid passes through the HT condenser 230, waste heat is rejected to a flow of coolant, and the working fluid returns to a liquid state before exiting the HT condenser 230. The liquid working fluid then enters the HT pump 222, and the cycle begins again.

The HT recuperator 272 is again located in the HT loop 220 between the HT pump 222 and the HT exhaust boiler 226, and again between the HT expander 228 and the HT condenser 230. In this way, the HT recuperator 272 transfers residual heat from the low pressure spent working fluid of the HT loop 220 passing from the HT expander 228 to the HT condenser 230, to the cool pressurized working fluid of the HT loop 220 passing from the HT pump 222 to the HT exhaust boiler 226. The HT recuperator 272 may handle only single-phase (gaseous) flow of the working fluid in the low pressure side of the HT loop 220, or may operate as an additional condenser in the HT loop 220. Similarly, the HT recuperator 272 may handle only single-phase (liquid) flow of the working fluid in the high pressure side of the HT loop 220, or may operate as an initial evaporator in the HT loop 220.

While the Organic Rankine Cycle Waste Heat Recovery System having Two Loops has been described with respect to at least one embodiment, the Organic Rankine Cycle Waste Heat Recovery System having Two Loops can be further modified within the spirit and scope of this disclosure, as demonstrated previously. This application is therefore intended to cover any variations, uses, or adaptations of the Organic Rankine Cycle Waste Heat Recovery System having Two Loops using its general principles. Further, this application is intended to cover such departures from the present disclosure as come within known or customary practice in the art to which the disclosure pertains and which fall within the limits of the appended claims.

REFERENCE NUMBER LISTING

| | |
|---|---|
| 10 | prior art Organic Rankine Cycle (ORC) Waste Heat Recovery |
| | (WHR) System |
| 12 | High Temperature (HT) Loop |
| 14 | Low Temperature (LT) Loop |
| 16 | Reciprocating engine |
| 18 | Common condenser/evaporator |
| 20 | LT pump |
| 22 | LT engine coolant heat exchanger/boiler |
| 24 | LT expander |
| 26 | LT condenser |
| 28 | HT pump |
| 30 | HT exhaust boiler |
| 32 | HT expander |
| 36 | T-s diagram of prior art ORC System LT loop |
| 38 | Temperature vertical axis |
| 40 | Entropy horizontal axis |
| 42 | p-h diagram of prior art ORC System LT loop |
| 44 | Temperature vertical axis |
| 46 | Enthalpy horizontal axis |
| 50 | Reciprocating engine |
| 52 | Intake manifold |
| 54 | Exhaust manifold |
| 56 | Engine cooling fan |
| 100 | ORC WHR System with two coupled loops |
| 110 | Common recuperator |
| 110A | Common recuperator HT fluid inlet |
| 110B | Common recuperator HT fluid outlet |
| 110C | Common recuperator LT fluid inlet |
| 110D | Common recuperator LT fluid outlet |
| 110E | Common recuperator first conduit |
| 110F | Common recuperator second conduit |
| 120 | HT loop |
| 122 | HT pump |
| 122A | HT pump fluid inlet |
| 122B | HT pump fluid outlet |
| 124 | HT filter |
| 126 | HT exhaust boiler |
| 126A | HT exhaust boiler fluid inlet |
| 126B | HT exhaust boiler fluid outlet |
| 126C | HT exhaust boiler exhaust inlet |
| 126D | HT exhaust boiler exhaust outlet |
| 126E | Exhaust gas bypass valve |
| 128 | HT expander |
| 128A | HT expander fluid inlet |
| 128B | HT expander fluid outlet |
| 128C | HT expander bypass valve |
| 130 | HT condenser |
| 130A | HT condenser fluid inlet |
| 130B | HT condenser fluid outlet |
| 130C | HT condenser coolant inlet |
| 130D | HT condenser coolant outlet |
| 150 | LT Loop |
| 152 | LT pump |
| 152A | LT pump fluid inlet |
| 152B | LT pump fluid outlet |
| 154 | LT filter |
| 156 | LT proportional valve |
| 158 | LT engine coolant heat exchanger/boiler |
| 158A | LT engine coolant heat exchanger/boiler fluid inlet |
| 158B | LT engine coolant heat exchanger/boiler fluid outlet |
| 158C | LT engine coolant heat exchanger/boiler coolant inlet |
| 158D | LT engine coolant heat exchanger/boiler coolant outlet |
| 160 | LT Charge Air Cooler (CAC) boiler |
| 160A | LT CAC boiler fluid inlet |
| 160B | LT CAC boiler fluid outlet |
| 160C | LT CAC boiler air inlet |
| 160D | LT CAC boiler air outlet |
| 162 | Combined LT engine coolant heat exchanger/boiler & LT CAC |
| | boiler |
| 164 | Combined LT engine coolant heat exchanger/boiler & LT CAC |
| | boiler fluid outlet |
| 166 | LT expander |
| 166A | LT expander fluid inlet |
| 166B | LT expander fluid outlet |
| 166C | LT bypass valve |
| 168 | LT condenser |
| 168A | LT condenser fluid inlet |
| 168B | LT condenser fluid outlet |
| 168C | LT condenser coolant inlet |
| 168D | LT condenser coolant outlet |
| 180 | Aftertreatment system |
| 182 | Turbocharger compressor |
| 184 | Turbocharger turbine |
| 186 | Turbocharger waste gate |
| 190 | Exhaust Gas Recirculation (EGR) valve |
| 200 | ORC WHR System with two decoupled loops |
| 220 | HT loop |
| 222 | HT pump |
| 222A | HT pump fluid inlet |
| 222B | HT pump fluid outlet |
| 224 | HT filter |
| 226 | HT exhaust boiler |
| 226A | HT exhaust boiler fluid inlet |
| 226B | HT exhaust boiler fluid outlet |
| 226C | HT exhaust boiler exhaust inlet |
| 226D | HT exhaust boiler exhaust outlet |
| 226E | Exhaust gas bypass valve |
| 228 | HT expander |
| 228A | HT expander fluid inlet |
| 228B | HT expander fluid outlet |
| 228C | HT expander bypass valve |
| 230 | HT condenser |
| 230A | HT condenser fluid inlet |
| 230B | HT condenser fluid outlet |
| 230C | HT condenser coolant inlet |
| 230D | HT condenser coolant outlet |
| 250 | LT Loop |
| 252 | LT pump |
| 252A | LT pump fluid inlet |
| 252B | LT pump fluid outlet |
| 254 | LT filter |
| 258 | LT engine coolant heat exchanger/boiler |
| 258A | LT engine coolant heat exchanger/boiler fluid inlet |
| 258B | LT engine coolant heat exchanger/boiler fluid outlet |
| 258C | LT engine coolant heat exchanger/boiler coolant inlet |
| 258D | LT engine coolant heat exchanger/boiler coolant outlet |
| 260 | LT CAC boiler |
| 260A | LT CAC boiler fluid inlet |
| 260B | LT CAC boiler fluid outlet |
| 260C | LT CAC boiler charge air inlet |
| 260D | LT CAC boiler charge air outlet |
| 262 | Combined LT engine coolant heat exchanger/boiler & LT CAC |
| | boiler |
| 264 | Second CAC |
| 266 | LT expander |
| 266B | LT expander fluid outlet |
| 266C | LT expander bypass valve |
| 268 | LT condenser |
| 268A | LT condenser fluid inlet |
| 268B | LT condenser fluid outlet |
| 268C | LT condenser coolant inlet |
| 268D | LT condenser coolant outlet |
| 270 | LT recuperator |
| 270A | LT recuperator fluid inlet from pump |
| 270B | LT recuperator fluid outlet to CAC boiler |
| 270C | LT recuperator fluid inlet from expander |
| 270D | LT recuperator fluid outlet to condenser |
| 270E | LT recuperator first conduit |
| 270F | LT recuperator second conduit |
| 272 | HT recuperator |
| 272A | HT recuperator fluid inlet from pump |
| 272B | HT recuperator fluid outlet to exhaust boiler |
| 272C | HT recuperator fluid inlet from expander |
| 272D | HT recuperator fluid outlet to condenser |
| 272E | HT recuperator first conduit |
| 272F | HT recuperator second conduit |
| 280 | Aftertreatment system |
| 282 | Turbocharger compressor |
| 284 | Turbocharger turbine |
| 286 | Turbocharger waste gate |
| 290 | EGR valve |

What is claimed is:

1. A vehicle having an Organic Rankine Cycle (ORC) Waste Heat Recovery (WHR) System, comprising:
at least one low temperature (LT) working fluid loop having in order:
at least one LT working fluid pump,
at least one of:
an LT engine coolant to working fluid heat exchanger, and
an LT Charge Air Cooler (CAC) boiler;
at least one LT working fluid expander, and
at least one LT working fluid condenser; and
at least one high temperature (HT) working fluid loop having in order:
at least one HT working fluid pump,
at least one HT exhaust to working fluid heat exchanger, and
at least one HT working fluid expander, and;
at least one recuperator having a first conduit being arranged within the at least one LT working fluid loop between the LT working fluid pump and the at least one of LT engine coolant to working fluid heat exchanger and LT CAC boiler;
the at least one recuperator having a second conduit being arranged within at least one of:
the at least one HT working fluid loop between the at least one HT working fluid expander and the at least one HT working fluid pump; and
the at least one LT working fluid loop between the at least one LT working fluid expander and the at least one LT working fluid condenser.

2. The vehicle of claim 1, wherein:
the CAC boiler receives a flow of charge air combined with a flow of exhaust gas recirculation.

3. The vehicle of claim 2, wherein:
the at least one HT loop is further provided with at least one HT condenser preceding the at least one HT working fluid pump; and
the at least one recuperator is a common recuperator with its second conduit arranged within the at least one HT working fluid loop between the at least one HT working fluid expander and the at least one HT condenser.

4. The vehicle of claim 2, wherein:
the at least one recuperator is an LT recuperator with its second conduit arranged within the at least one LT working fluid loop between the at least one LT working fluid expander and the at least one LT working fluid condenser;
the at least one HT loop is further provided with at least one HT condenser preceding the at least one HT working fluid pump; and
the at least one HT loop is further provided with an HT recuperator having a first conduit arranged between the at least one HT working fluid pump and the at least one HT exhaust to working fluid heat exchanger, and a second conduit arranged between the at least one HT working fluid expander and the at least one HT condenser.

5. The vehicle of claim 1, wherein:
the LT working fluid condenser further comprises a working fluid to coolant heat exchanger.

6. The vehicle of claim 1, further comprising:
both the LT engine coolant to working fluid heat exchanger and the LT CAC boiler, the LT engine coolant to working fluid heat exchanger and the LT CAC boiler being one of:
arranged in parallel and being provided with an LT proportional valve controlling working fluid thereto; and
arranged in series.

7. The vehicle of claim 1, further comprising:
an EGR cooler evaporator boiler being arranged in the LT working fluid loop subsequent to the at least one of LT engine coolant to working fluid heat exchanger and LT Charge Air Cooler (CAC) boiler.

8. The vehicle of claim 1, further comprising:
at least one of:
an exhaust gas bypass valve selectively bypassing the at least one HT exhaust to working fluid heat exchanger,
an LT working fluid expander bypass valve selectively bypassing the at least one LT working fluid expander, and
an HT working fluid expander bypass valve selectively bypassing the at least one HT working fluid expander.

9. An Organic Rankine Cycle (ORC) Waste Heat Recovery (WHR) System of a vehicle, comprising:
at least one low temperature (LT) working fluid loop having in order:
at least one LT working fluid pump,
at least one of:
an LT engine coolant to working fluid heat exchanger, and
an LT Charge Air Cooler (CAC) boiler;
at least one LT working fluid expander, and
at least one LT working fluid condenser; and
at least one high temperature (HT) working fluid loop having in order:
at least one HT working fluid pump,
at least one HT exhaust to working fluid heat exchanger, and
at least one HT working fluid expander, and;
at least one recuperator having a first conduit being arranged within the at least one LT working fluid loop between the LT working fluid pump and the at least one of LT engine coolant to working fluid heat exchanger and LT CAC boiler;
the at least one recuperator having a second conduit being arranged within at least one of:
the at least one HT working fluid loop between the at least one HT working fluid expander and the at least one HT working fluid pump; and
the at least one LT working fluid loop between the at least one LT working fluid expander and the at least one LT working fluid condenser.

10. The ORC WHR System of claim 9, wherein:
the CAC boiler receives a flow of charge air combined with a flow of exhaust gas recirculation.

11. The ORC WHR System of claim 10, wherein:
the at least one HT loop is further provided with at least one HT condenser preceding the at least one HT working fluid pump; and
the at least one recuperator is a common recuperator with its second conduit arranged within the at least one HT working fluid loop between the at least one HT working fluid expander and the at least one HT condenser.

12. The ORC WHR System of claim 10, wherein:
the at least one recuperator is an LT recuperator with its second conduit arranged within the at least one LT working fluid loop between the at least one LT working fluid expander and the at least one LT working fluid condenser;
the at least one HT loop is further provided with at least one HT condenser preceding the at least one HT working fluid pump; and
the at least one HT loop is further provided with an HT recuperator having a first conduit arranged between the at least one HT working fluid pump and the at least one HT exhaust to working fluid heat exchanger, and a second conduit arranged between the at least one HT working fluid expander and the at least one HT condenser.

13. The ORC WHR System of claim 9, wherein:
the LT working fluid condenser further comprises a working fluid to coolant heat exchanger.

14. The ORC WHR System of claim 9, further comprising:
both the LT engine coolant to working fluid heat exchanger and the LT CAC boiler, the LT engine coolant to working fluid heat exchanger and the LT CAC boiler being one of:
arranged in parallel and being provided with an LT proportional valve controlling working fluid thereto; and
arranged in series.

15. The ORC WHR System of claim 9, further comprising:
an EGR cooler evaporator boiler being arranged in the LT working fluid loop subsequent to the at least one of LT engine coolant to working fluid heat exchanger and LT Charge Air Cooler (CAC) boiler.

16. The ORC WHR System of claim 9, further comprising:
at least one of:
an exhaust gas bypass valve selectively bypassing the at least one HT exhaust to working fluid heat exchanger,
an LT working fluid expander bypass valve selectively bypassing the at least one LT working fluid expander, and
an HT working fluid expander bypass valve selectively bypassing the at least one HT working fluid expander.

17. A method of recovering energy from waste heat generated by a vehicle, comprising the steps of:
providing at least one low temperature (LT) ORC WHR working fluid loop having in order:
at least one LT working fluid pump,
at least one of:
an LT engine coolant to working fluid heat exchanger, and
an LT Charge Air Cooler (CAC) boiler;
at least one LT working fluid expander, and
at least one LT working fluid condenser; and
providing at least one high temperature (HT) ORC WHR working fluid loop having in order:
at least one HT working fluid pump,
at least one HT exhaust to working fluid heat exchanger, and
at least one HT working fluid expander, and;
arranging a first conduit of at least one recuperator within the at least one LT ORC WHR working fluid loop between the LT working fluid pump and the at least one of LT engine coolant to working fluid heat exchanger and LT CAC boiler;
arranging a second conduit of the at least one recuperator within at least one of:
the at least one HT working fluid loop between the at least one HT working fluid expander and the at least one HT working fluid pump; and
the at least one LT working fluid loop between the at least one LT working fluid expander and the at least one LT working fluid condenser.

18. The method of claim 17, further comprising the step of:
receiving a flow of charge air combined with a flow of exhaust gas recirculation into the CAC boiler.

19. The method of claim 18, further comprising the steps of:
providing the at least one HT loop with at least one HT condenser preceding the at least one HT working fluid pump; and
arranging the second conduit of the at least one recuperator within the at least one HT working fluid loop between the at least one HT working fluid expander and the at least one HT condenser.

20. The method of claim 18, further comprising the steps of:
arranging the second conduit of the at least one recuperator within the at least one LT working fluid loop between the at least one LT working fluid expander and the at least one LT working fluid condenser;
providing the at least one HT loop with at least one HT condenser preceding the at least one HT working fluid pump;
providing the at least one HT loop with a second recuperator;
arranging a first conduit of the second recuperator between the at least one HT working fluid pump and the at least one HT exhaust to working fluid heat exchanger; and
arranging a second conduit of the second recuperator between the at least one HT working fluid expander and the at least one HT condenser.
